(19) United States
(12) Patent Application Publication
(10) Pub. No.: US 2013/0155242 A1
(43) Pub. Date: Jun. 20, 2013

(54) Stand-Alone, Portable Video Alarm System

(71) Applicants: Jorge Hevia, Lynbrook, NY (US); Thomas Karl, Lindenhursl, NY (US); Jose Colucciello, Melbourne Beach, FL (US)

(72) Inventors: Jorge Hevia, Lynbrook, NY (US); Thomas Karl, Lindenhursl, NY (US); Jose Colucciello, Melbourne Beach, FL (US)

(73) Assignee: VIDEO ALERT, LLC

(21) Appl. No.: 13/327,639

(22) Filed: Dec. 15, 2011

(51) Int. Cl. H04N 7/18

(52) U.S. Cl. 348/152; 348/E07.085

(57) ABSTRACT

A stand-alone, portable video alarm system for monitoring a protected area selected by a user is described that includes a video detection sensor for issuing alarm system signals, including an intrusion alarm signal when the video detection sensor detects motion indicative of an intruder within the protected area, a secondary detection sensor to detect the intruder within said protected area, a modem for communicating command signals to and alarm system signals from the video alarm system, a user-controlled mobile display for transmitting said command signals to the video alarm system through said modem and for receiving said alarm status signals from the video alarm system through said modem, wherein the intrusion alarm signal is communicated from the video alarm system through the modem and onto the user-controlled mobile display only when the intruder is detected by both the video detection sensor and the secondary detection sensor.

### FIELD OF THE INVENTION

This invention is generally directed to an alarm system for monitoring a protected area to detect the presence of an intruder. More particularly, the present invention provides a stand-alone, portable video alarm system that is inexpensive and tamper resistant, yet also allows a user not only to receive remote alarm signals, but also to receive video verification to determine the cause of any such alarm signals.

### BACKGROUND OF THE INVENTION

For many years, various alarm systems have been utilized to protect residential, governmental and commercial properties from unauthorized intruders. Such alarm systems typically would incorporate a control panel, a user interface (such as a keypad) to program and control the system, and an array of intrusion sensors such as motion detectors, glass break detectors, door contacts, window contacts, etc. Such alarm systems would communicate any detected alarm conditions to a central monitoring station, which would process the alarm report and contact the proper authorities (and/or user) to respond to the event.

While conventional alarm systems have achieved significant market penetration with respect to upscale private homes, government institutions and business establishments, the high cost of installation and monthly recurring charges associated with central monitoring stations have resulted in a lack of penetration in apartments, mobile homes, temporary residences, boats, etc., where many users deem the cost-benefit analysis as not warranting the installation of a conventional alarm system. Moreover, users who frequently relocate often consider the costs of initial installation as impractical even in a private home, business, etc., since when one moves from one location to another, the alarm system that had already been paid for is not transportable.

Due to the extensive use of alarm systems, law enforcement authorities are more recently hesitant to respond to an alarm report if an occupant has a history of false alarm reports. Before responding to an alarm condition, many municipalities now require separate video verification that would indicate the presence of an intruder before responding to the alarm condition. Regrettably, the use of a separate video verification system further increases the cost of the alarm system, and makes such systems even less practical in many applications for reasons previously described.

It is therefore a primary object of the present invention to provide a new and improved alarm system that is a stand-alone unit and readily portable.

It is yet another object of the present invention to provide a new and improved alarm system that provides a single video sensor that provides both motion sensing and video verification.

It is still yet a further object of the present invention to provide a new and improved alarm system that requires no professional installation.

It is still an additional object of the present invention to provide a new and improved alarm system that provides direct communication to a user through a mobile device application.

It is an additional object of the present invention to provide a new and improved alarm system that provides an anti-tamper function to ensure that an intruder has not deliberately disabled the alarm system.

It is still an additional object of the present invention to provide a new and improved alarm system that provides a supervisory function to confirm that the alarm system is operational.

It is still a further object of the present invention to provide a new and improved alarm system that is inexpensive to purchase, install, and operate.

Other objects and advantages of the present invention will become apparent from the specifications in the drawings.

### SUMMARY OF THE INVENTION

Briefly stated and in accordance with the preferred embodiment of the present invention, a stand-alone, portable video alarm system for monitoring a protected area selected by a user is described that incorporates a video detection sensor that utilizes known pixel-data analytics, such that the video detection sensor can both detect motion indicative of an intruder within the protected area as well as provide video. A modem is provided to communicate the alarm system signals to a user through a mobile display such as on a smart phone, a hand-held tablet, or any other electronic device having a display apparatus. The stand-alone, portable video alarm system of the present invention thereby not only communicates an intrusion alarm signal, but also provides video that verifies the intrusion alarm signal. The user may also, through the mobile apparatus, supply command signals to the video alarm system.

In certain applications, a secondary detection sensor may be utilized to confirm a detection of an intruder within the protected premises prior to an intrusion alarm signal being issued. The use of such a secondary detection sensor will minimize false alarms. It is also possible to utilize a remote server system to ensure that the video alarm system of the present invention is operating correctly and/or has not been tampered with by an intruder.

### BRIEF DESCRIPTION OF THE DRAWINGS

While the specification concludes with claims particularly pointing out and distinctly claiming the subject matter regarded as the invention herein, it is believed that the present invention will be more readily understood upon consideration of the description, taken in conjunction with the accompanying drawings, wherein:

FIG. 1 is a schematic illustration of a first embodiment of a stand-alone, portable video alarm system of the present invention utilizing a single video detection sensor to both detect the presence of an intruder in a protected, monitored area and provide video verification of the intruder;

FIG. 2 is a schematic illustration of a second embodiment of a stand-alone, portable video alarm system of the present invention that is similar to the video alarm system of FIG. 1, but incorporates a secondary detection sensor to confirm the detection of an intruder in a protected area;

FIG. 3 is a schematic illustration of the server system utilized in conjunction with the stand-alone, portable video alarm system of the present invention;

FIG. 4 is a flow chart of the alarm processing of the stand-alone portable video alarm system of FIG. 2 of the present invention;

FIG. 5 is a flow chart of the interface control processing of the stand-alone portable video system of the present invention;

FIG. 6 is a flow chart of the supervision function of the stand-alone, portable video alarm system of the present invention to determine if the video alarm system is operational; and

FIG. 7 is a flow chart of the anti-tamper function of the stand-alone, portable video alarm system of the present invention to determine if an intruder has deliberately tampered with the video alarm system.

### DESCRIPTION OF THE PREFERRED EMBODIMENT

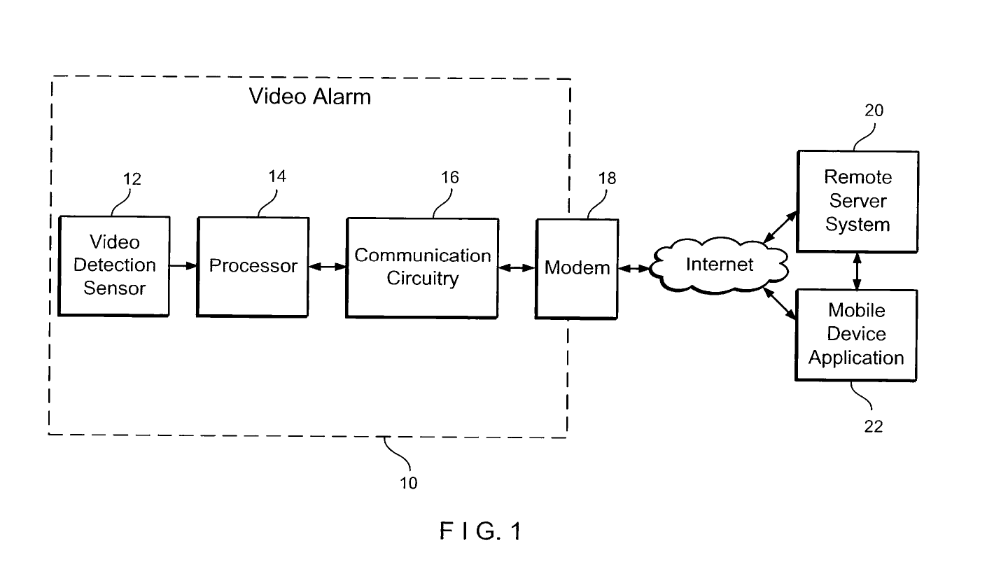

A first embodiment of the present invention is depicted in the schematic illustration of FIG. 1. A stand-alone, portable video alarm system 10 is shown which includes a video detection sensor 12, a microprocessor 14, and communication circuitry 16. Video detection sensor 12 utilizes known pixel-data analytical software operated in microprocessor 14, which allows video detection sensor 12 to not only record video, but to ascertain movement within a protected area. Although not depicted in FIG. 1, video alarm system 10 is typically powered by a plug-in adapter, although it would be possible for video alarm system 10 to be powered by an internal power supply such as a battery.

A modem 18 is depicted as being partially within the dashed box representative of video alarm system 10 and partially outside the dashed box representative of video alarm system 10 in order to demonstrate that modem 18 can either be an integral part of video alarm system 10 or separate from video alarm system 10. In instances where modem 18 is not an integral part of video alarm system 10, modem 18 can be any existing modem within a user's home or other protected area. Moreover, it should be noted that, for purposes of this specification and the appended claims, that modem 18 is defined broadly as any device that permits access to the internet, such as a router, a network appliance, a cable modem, a “hot spot” connection, etc.

Video alarm system 10 is capable of issuing intrusion alarm signals, which can be passed through modem 18, over the internet, and onto remote server system 20 and/or mobile device application 22. It should be understood that mobile device application 22 can be a smart phone, a tablet device, a laptop, or any other mobile device that has—or can be connected to—a video display. The video alarm system of FIG. 1 allows both intrusion detection and video verification in a portable and inexpensive device.

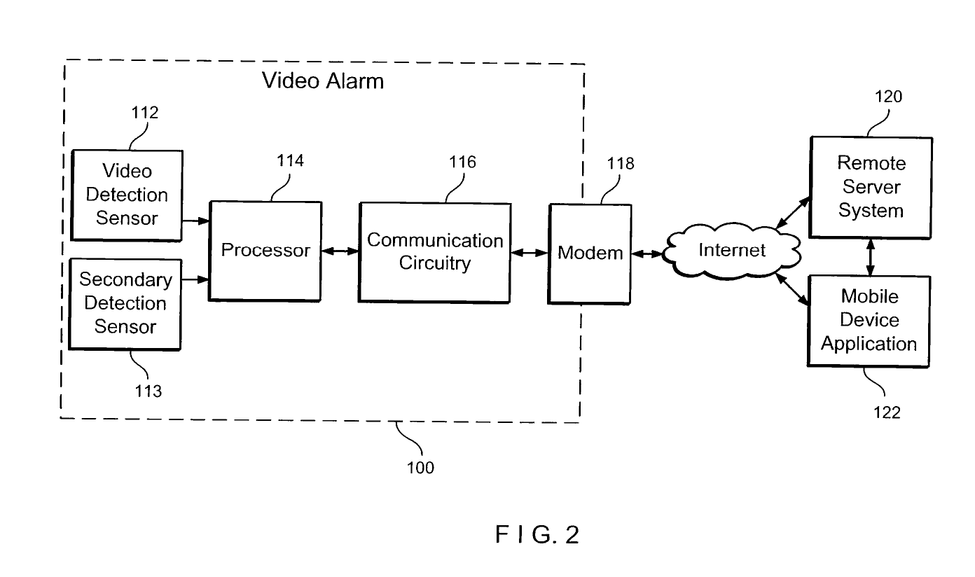

The use of a single detection technology (even video) often can result in a higher number of false alarms then is desirable. Thus, in FIG. 2, a second embodiment of the present invention is depicted wherein a secondary detection sensor 113 is incorporated to confirm the intruder detection made by video detection sensor 112. Secondary detection sensor 113 can be a microwave sensor, a passive infrared sensor, an ultrasonic sensor, or any other sensor known in the art. The operation of the systems in both FIG. 1 and FIG. 2 are similar and will be described hereinafter in further detail.

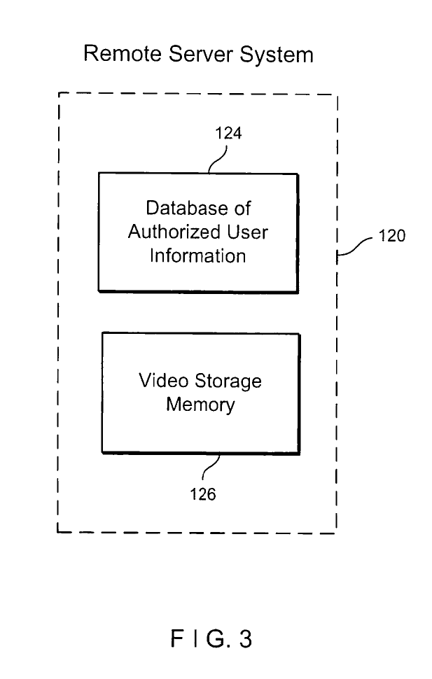

FIG. 3 is a more detailed depiction of remote server system 120. Remote server system 120 will, in the preferred embodiments, optionally include both a database of authorized users 124 and a video storage memory 126. Although not depicted, a similar database of authorized use information and video storage memory can also be included within video alarm system 100. If an attempt to control video alarm system is received from a device not stored within database 124, access will be denied. Video storage memory 126 can be made to maintain video of significant events detected by video alarm system 100.

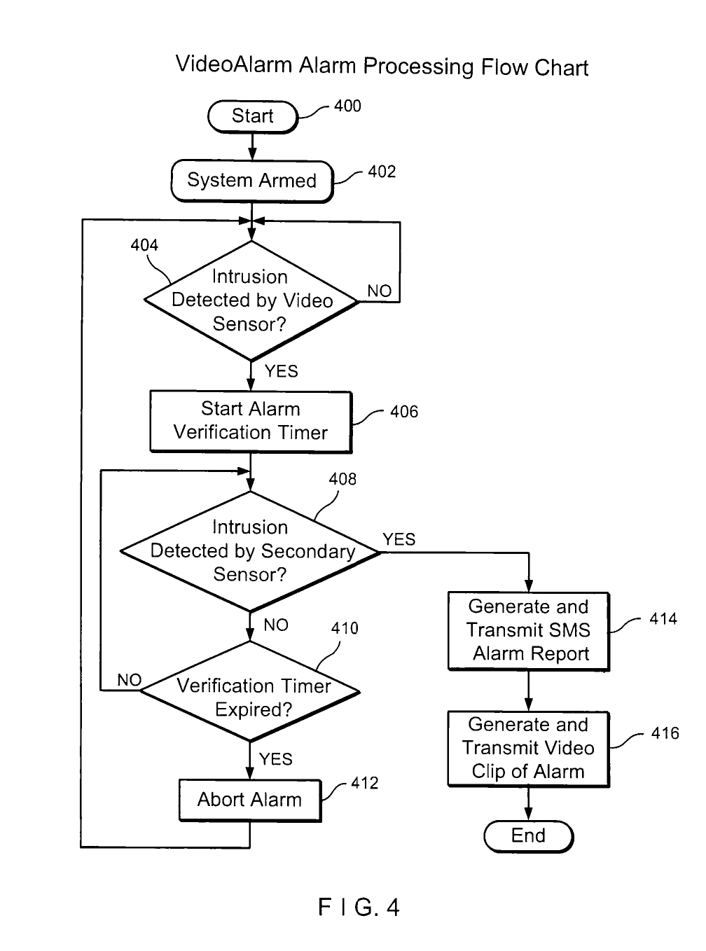

FIG. 4 describes the process of issuing an intrusion alarm signal in conjunction with an embodiment of the present invention that utilizes two sensors (FIG. 2). The process is started (box 400) and a determination is made as to whether video alarm system in indeed armed/ON (box 402.) A determination is then made (decision box 404) as to whether an intruder is detected by video detection sensor 112. If no detection is made, no further action occurs in this running of the software. However, if an intruder is detected by video detection sensor 112, a verification timer is started (box 406). Secondary detection sensor 113 then determines if it also senses the presence of an intruder in a protected zone (box 408). If no detection of an intruder is made by secondary detection sensor 113 prior to the expiration of the verification timer (box 410), no alarm signal is issued (box 412). Conversely, if secondary detection sensor 113 detects the presence of an intruder within the expiration of the verification timer, an alarm report is generated (box 414), and a video clip is generated and transmitted (box 416). In the flow chart of FIG. 4, video detection sensor 112 makes the first determination of the presence of an intruder. However, it will be understood by those skilled in the art that secondary detection sensor 113 can indeed be utilized to first detect the presence of an intruder with confirmation detection by video detection sensor 112 thereafter.

The processing of an alarm report with video verification in the embodiment of FIG. 1, wherein no secondary detection sensor is incorporated is less complex. If video detection sensor 12 detects the presence of an intruder, an alarm and video clip for verification is sent. There is no verification timer required.

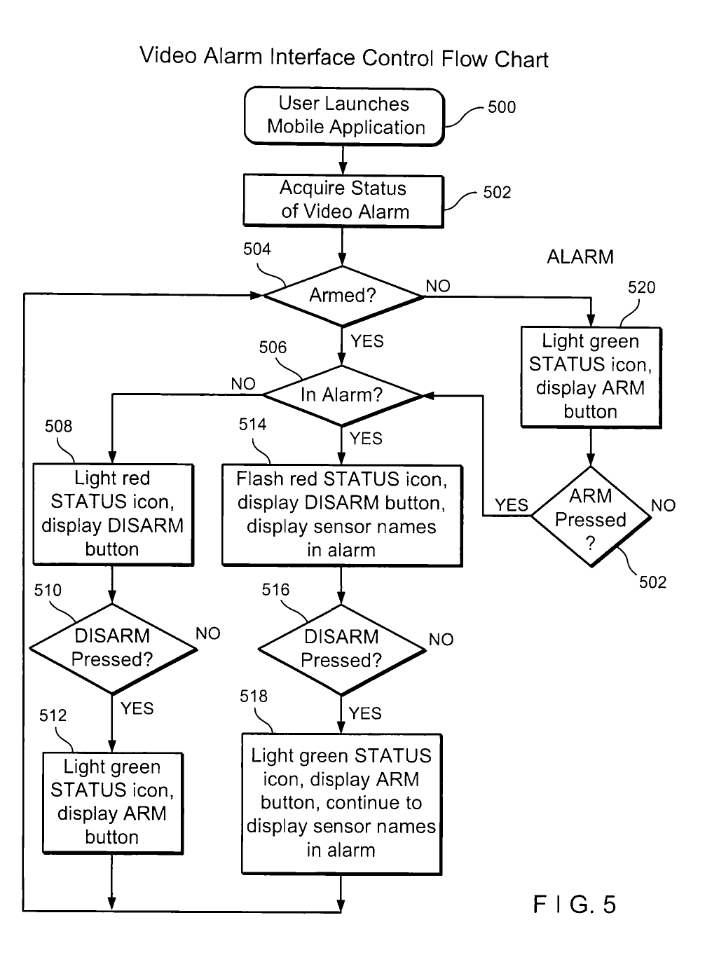

FIG. 5 depicts how a user can utilize mobile device application 122 to control video alarm system 100. The first step is that the user will launch the mobile application software (box 500). Such mobile application software programs are easily written by a programmer and are designed to operate on mobile devices such as an IPHONE®, ANDROID® or BLACKBERRY® based device. An example of such existing mobile application technology is the NAPCO® MyRemoteKeypad mobile application, which provides system control of conventional alarm systems manufactured by the assignee of the subject invention. In the present instance, the mobile application software on mobile application device 122 will provide remote control of video alarm system 100.

Next a determination is made as to whether video alarm system 100 is armed or disarmed (box 502 and box 504). If indeed video alarm system 100 is armed, a determination is then made to determine if video alarm system 100 is in alarm (box 506). If video alarm system 100 is not in alarm, the user can determine whether it wishes to disarm or arm the system (box 508, box 510, and box 512). If, at box 506, a determination is made that video alarm system 100 is in alarm, the user will first be provided with a display of the sensor means that are an alarm so that a determination can be made whether to disarm or arm the system (box 514, box 516 and box 518). If, at decision box 504, video alarm system 100 is deemed not to be armed, the user will be able to determine to arm the system or leave the system disarmed (box 520 and box 522).

The operations described in conjunction with FIG. 4 and FIG. 5 can be performed without accessing remote server system 120. However, while permitting control of video alarm system 100 and the issuing of intrusion alarm signals from video alarm system 100, these direct operations between video alarm system 100 and mobile device application 122 do not allow the remote user to determine more specific, important information such as whether the system is operational or whether the system has been intentionally tampered with to render it inoperable.

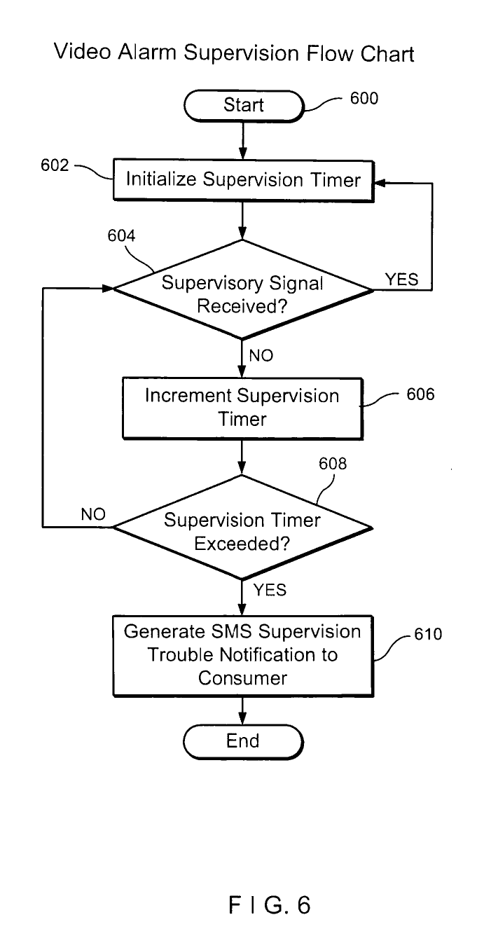

The supervisory function of FIG. 6 typically would be provided for at remote server system 120. The operation is started (box 600) and a supervision timer is initialized (box 602). Next, a determination will be made to ascertain if a supervisory signal that is periodically programmed to be issued by video alarm system 100 is received by remote server system 120 (box 604). If the periodic supervisory signal from video alarm system 100 is received at remote server system 120, video alarm system 100 is deemed to be operational. However, if an expected supervisory signal is not received, the supervision timer will be incremented (box 606) until the supervisory timer has exceeded its predetermined threshold (box 608). If no supervisory signal is received within the time allowed for by the supervision timer, a trouble notification will be forwarded from remote service system 12 to mobile device application 122. The user can then determine how best to make the system operational or whether it is important that the system be made operational.

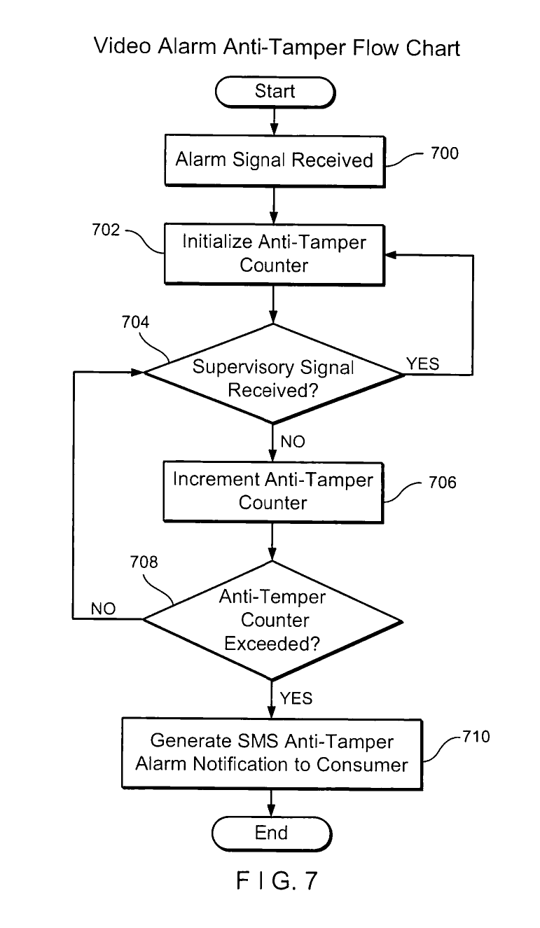

FIG. 7 describes the functionality of what, in essence, is a particular type of failure of receiving the expected supervisory signal (i.e., when an intruder intentionally has attempted to disable the device). When an intrusion alarm signal is received (box 700) an anti-tamper counter is initialized (box 702). Remote server system 120 will then look for the periodic supervisory signal issued by video alarm system 100 (box 704). If the supervisory signal is received when expected, the system is still operational although an intruder may have breached the protected zone. However, if no supervisory signal is received within the time frame permitted by the anti-tampered counter (box 706 and box 708), remote server system 120 will generate an anti-tamper alarm notification and forward it to user mobile device application 122 (box 710). Under such a circumstance, the user then would know that no signals are being received because an intruder intentionally intended to disable the device, as opposed to other possible failures such as power source failures, connectivity problems, broken sensors, etc. that might not require immediate action.

It will be apparent from the foregoing description that the present invention provides a novel and inexpensive stand-alone, portable video alarm system that incorporates supervisory features, anti-tamper features, and inexpensive video verification of intrusion alarm signals. The video alarm system provided herein is so portable that it can provide protection in environments such as hotels and/or short-term residences. In such environments, the video verification feature allows the user to determine if the intruder is actually an authorized person such as a maid, as opposed to an unauthorized user such as a burglar.

While there has been shown and described what is presently considered to be the preferred embodiment of this invention, it will be obvious to those skilled in the art that various modifications and changes can be made without departing from the broader aspects of this invention. It is, therefore, aimed in the appended claims to cover all such changes and modifications that fall within the true scope and spirit of the invention.

We claim:

1. A stand-alone, portable video alarm system for monitoring a protected area selected by a user comprising:
a video detection sensor for issuing alarm system signals, including an intrusion alarm signal when said video detection sensor detects motion indicative of an intruder within said protected area;
a modem for communicating command signals to and said alarm system signals from said video detection sensor:
a user-controlled mobile display for transmitting said command signals to said video alarm system through said modem and for receiving said alarm status signals from said video alarm system through said modem; and
wherein said intrusion alarm signal communicated from said video alarm system through said modem and onto said user-controlled mobile display includes video that verifies said intrusion alarm signal.

2. The stand-alone portable video alarm system of claim 1 further comprising an audible alarm apparatus.

3. The stand-alone, portable video alarm system of claim 1 further comprising a plug-in power adapter.

4. The stand-alone, portable video alarm system of claim 1 further comprising a remote server in communication with said modem.

5. The stand-alone, portable video alarm system of claim 4 wherein said alarm system signals include a timed supervision signal transmitted to said remote server whereby receipt by said remote server of said supervision signal within a predetermined time is indicative of a properly functioning video alarm system and failure to receive said supervision signal within said predetermined time is indicative of a non-functioning video alarm system.

6. The stand-alone, portable video alarm system of claim 5 wherein said remote server issues a trouble signal to said user-controlled mobile display when said video alarm system is indicated as non-functioning based on the failure to receive said supervision signal within said predetermined time.

7. The stand-alone, portable video alarm system of claim 5 wherein said intrusion alarm signal is transmitted to said remote server which activates an anti-tamper counter.

8. The stand-alone, portable video alarm system of claim 7 wherein when said anti-tamper counter expires without receipt by said remote server of said timed supervisory signal, said remote server transmits a tamper alarm signal to said user-controlled mobile display.

9. The stand-alone, portable video alarm system of claim 1 further comprising a local memory to store video from said video detection sensor.

10. The stand-alone, portable video alarm system of claim 4 further comprising a remote memory at said remote server to store video from said video detection sensor.

11. The stand-alone, portable video alarm system of claim 1 further comprising a local database for storing authorized user information.

12. The stand-alone, portable video alarm system of claim 4 further comprising a remote database at said remote server for storing authorized user information.

13. A stand-alone, portable video alarm system for monitoring a protected area selected by a user comprising:
a video detection sensor for issuing alarm system signals, including an intrusion alarm signal when said video detection sensor detects motion indicative of an intruder within said protected area;
a secondary detection sensor to detect said intruder within said protected area;
a modem for communicating command signals to and said alarm system signals from said video detection sensor;
a user-controlled mobile display for transmitting said command signals to said video alarm system through said modem and for receiving said alarm status signals from said video alarm system through said modem; and
wherein said intrusion alarm signal is communicated from said video alarm system through said modern and onto said user-controlled mobile display only when said intruder is detected by both said video detection sensor and said secondary detection sensor, and said intrusion alarm signal includes video that verifies said intrusion alarm signal.

14. The stand-alone portable video alarm system of claim 13 further comprising an audible alarm apparatus.

15. The stand-alone, portable video alarm system of claim 13 further comprising a plug-in power adapter.

16. The stand-alone, portable video alarm system of claim 13 further comprising a remote server in communication with said modem.

17. The stand-alone, portable video alarm system of claim 16 wherein said alarm system signals include a timed supervision signal transmitted to said remote server whereby receipt by said remote server of said supervision signal within a predetermined time is indicative of a properly functioning video alarm system and failure to receive said supervision signal within said predetermined time is indicative of a non-functioning video alarm system.

18. The stand-alone, portable video alarm system of claim 17 wherein said remote server issues a trouble signal to said user-controlled mobile display when said video alarm system is indicated as non-functioning based on the failure to receive said supervision signal within said predetermined time.

19. The stand-alone, portable video alarm system of claim 17 wherein said intrusion alarm signal is transmitted to said remote server which activates an anti-tamper counter.

20. The stand-alone, portable video alarm system of claim 19 wherein when said anti-tamper counter expires without receipt by said remote server of said timed supervisory signal, said remote server transmits a tamper alarm signal to said user-controlled mobile display.

21. The stand-alone, portable video alarm system of claim 13 further comprising a local memory to store video from said video detection sensor.

22. The stand-alone, portable video alarm system of claim 16 further comprising a remote memory at said remote server to store video from said video detection sensor.

23. The stand-alone, portable video alarm system of claim 13 further comprising a local database storing authorized user information.

24. The stand-alone, portable video alarm system of claim 16 further comprising a remote database at said remote server for storing authorized user information.

25. The stand-alone, portable video alarm system of claim 13 wherein said secondary detection sensor is a passive infrared sensor.

26. The stand-alone, portable video alarm system of claim 13 wherein said secondary detection sensor is a microwave sensor.

27. The stand-alone, portable video alarm system of claim 11 wherein said secondary detection sensor is an ultrasonic sensor.
